(19) United States
(12) Patent Application Publication
(10) Pub. No.: US 2016/0030961 A1
(43) Pub. Date: Feb. 4, 2016

(54) High efficiency pump bottle

(71) Applicant: David Patton, Dubuque, IA (US)

(72) Inventor: David Patton, Dubuque, IA (US)

(21) Appl. No.: 14/818,266

(22) Filed: Aug. 4, 2015

Related U.S. Application Data
(60) Provisional application No. 62/032,721, filed on Aug. 4, 2014.

(51) Int. Cl. B05B 11/00

(52) U.S. Cl. CPC B05B 11/0037; B05B 11/30

(57) ABSTRACT

A high efficiency pump bottle provides an inverted cone shape at its lower end. The supply tube to the pump is located at the apex of the cone, thus enabling nearly all of the container contents to be pumped out.

### CROSS-REFERENCE TO RELATED APPLICATIONS

This Application claims the benefit of U.S. Provisional Application No. 62/032,721, filed Aug. 04, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to product containers, and in particular to a high efficiency pump bottle. Certain types of household products, such as hand lotion and shampoo, are frequently provided in pump bottles. Unfortunately, the design of the bottle ensures that a small but significant amount of the product is wasted as the bottle is emptied, since the supply tube cannot reach all of the product in the bottom of the bottle. With certain products such as salon conditioners costing $25.00 or more per bottle, the cumulative loss in dollars over the course of several years can be substantial. A high efficiency pump bottle, which delivers all but a few drops of the product contained within it as the bottle is emptied, would resolve this problem.

### SUMMARY OF THE INVENTION

Accordingly, the invention is directed to a high efficiency pump bottle. The reservoir provides an inverted cone shape at its lower end. The supply tube to the pump is located at the apex of the cone, thus enabling nearly all of the container contents to be pumped out.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

FIG. 1 is a side sectional view of the first exemplary embodiment, displaying the bottle 10, the reservoir 10A, the pump 11, the nozzle 12, the supply tube 13, the recess 14, the bottom surface 15, the inverted cone apex 16, and the concave openings 17.

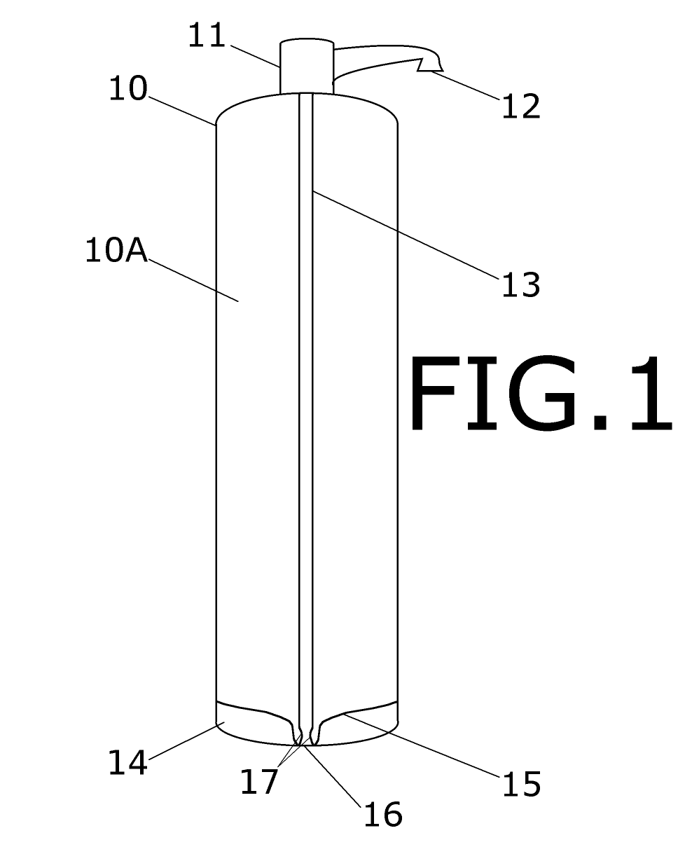

### DETAILED DESCRIPTION OF THE INVENTION

Referring now to the invention in more detail, the invention is directed to a high efficiency pump bottle 10. The reservoir 10A provides an inverted cone shape 16 at the lower end of the reservoir 10A. The supply tube 13 to the pump 11 is located at the apex 16 of the cone, thus enabling nearly all of the container contents to be pumped out.

The first exemplary embodiment provides a pump bottle 10. The bottle 10 comprises a reservoir 10A and a pump 11, which is preferably affixed by screw threads to a circular neck at the upper end of the reservoir 10A. The pump 11 provides a nozzle 12 to dispense the product from the reservoir 10A, and a supply tube 13 which draws product out of the reservoir 10A when the pump 11 is operated.

The reservoir 10A provides an inverted cone shape at its lower end, which is surrounded by a ring-shaped recess 14, which terminates at the bottom in an inverted cone apex 16. The lower end of the supply tube 13 is located at the lower tip of the inverted cone apex 16. Cut into the sides of the supply tube 13 are a pair of concave openings 17, each diametrically opposed to the other. As the reservoir 10A is gradually emptied, the remaining product collects in the apex of the reservoir and flows into the concave openings 17. This enables the supply tube 13 to recover all but a few drops of the product before the bottle 10 is discarded.

To use the first exemplary embodiment, the user holds the bottle 10 in one hand and presses downward on the pump 11 with a fingertip. Product from the reservoir 10A is collected by the supply tube 13 and dispensed by the nozzle 12.

The bottle 10 and the supply tube 13 are preferably manufactured from a semi-rigid, durable material which is waterproof and shatterproof, such as plastic. The pump 11 and the nozzle 12 are preferably manufactured from a rigid, durable material which is waterproof, such as plastic or steel. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A high efficiency pump bottle, comprising:
(a) a reservoir;
(b) said reservoir having an upper end and a lower end;
(c) said lower end having an inverted cone shape;
(d) said inverted cone shape having an apex;
(e) a supply tube;
(f) a pump;
(g) an upper end of said supply tube being connected to said pump;
(g) a lower end of said supply tube being of a length such that said supply tube terminates at said apex;
(h) said supply tube having an opening at a lower end; and
(i) said pump being configured to pull contents of said reservoir through said supply tube.

2. The high efficiency pump bottle of claim 1, wherein said opening at a lower end is a pair of concave openings being located diametrically opposite of each other.

3. The high efficiency pump bottle of claim 1, wherein said pump further comprises a nozzle.

4. The high efficiency pump bottle of claim 2, wherein said pump further comprises a nozzle.

5. The high efficiency pump bottle of claim 1, wherein said reservoir has a circular neck at said upper end.

6. The high efficiency pump bottle of claim 5, wherein said pump is removably affixed to said circular neck by a screw thread.

7. The high efficiency pump bottle of claim 2, wherein said reservoir has a circular neck at said upper end.

8. The high efficiency pump bottle of claim 7, wherein said pump is removably affixed to said circular neck by a screw thread.

9. The high efficiency pump bottle of claim 3, wherein said reservoir has a circular neck at said upper end.

10. The high efficiency pump bottle of claim 9, wherein said pump is removably affixed to said circular neck by a screw thread.

11. The high efficiency pump bottle of claim 4, wherein said reservoir has a circular neck at said upper end.

12. The high efficiency pump bottle of claim 11, wherein said pump is removably affixed to said circular neck by a screw thread.

13. The high efficiency pump bottle of claim 1, wherein said opening at a lower end is cut at a thirty degree angle with respect to said supply tube.

14. The high efficiency pump bottle of claim 13, wherein said pump further comprises a nozzle.

15. The high efficiency pump bottle of claim 14, wherein said reservoir has a circular neck at said upper end.

16. The high efficiency pump bottle of claim 15, wherein said pump is removably affixed to said circular neck by a screw thread.
